(19) United States
(12) Patent Application Publication
(10) Pub. No.: US 2013/0231593 A1
(43) Pub. Date: Sep. 5, 2013

(54) NON-INVASIVE SYSTEM TO REGULATE INTRACRANIAL PRESSURE

(71) Applicants: Demetris Yannopoulos, Edina, MN (US); Keith G. Lurie, Minneapolis, MN (US)

(72) Inventors: Demetris Yannopoulos, Edina, MN (US); Keith G. Lurie, Minneapolis, MN (US)

(21) Appl. No.: 13/782,913

(22) Filed: Mar. 1, 2013

Related U.S. Application Data
(60) Provisional application No. 61/606,153, filed on Mar. 2, 2012.

(51) Int. Cl. A61H 9/00

(52) U.S. Cl. CPC A61H 9/00
USPC 601/6

(57) ABSTRACT

A method is provided for non-invasively lowering a person's ICP and increasing cerebral perfusion pressure. The method may include the step of actively lowering the person's intrathoracic pressure. Also, the person's effective circulating blood volume is lowered while the person's intrathoracic pressure is lowered to thereby non-invasively reduce venous blood volume in the brain to treat elevated intracranial pressure.

### CROSS REFERENCES TO RELATED APPLICATIONS

This application claims the benefit of U.S. Provisional Application No. 61/606,153, filed Mar. 2, 2012, the complete disclosure of which is herein incorporated by reference.

### BACKGROUND OF THE INVENTION

This invention relates generally to the field of non-invasive treatments, and in particular to the reduction of intracranial pressures and brain swelling.

### BRIEF SUMMARY OF THE INVENTION

Elevated intracranial pressure is a leading cause of brain damage and death in patients with a stroke, cerebral bleed, brain surgery, cardiac arrest, brain edema, and other forms of traumatic and non-traumatic brain injury. Treatment options, especially non-invasive treatment options, are limited. This invention provides a novel systems to non-invasively reduce elevated intracranial pressure and brain edema.

More specifically, in one exemplary embodiment a method is provided for non-invasively lowering a person's ICP and increasing cerebral perfusion pressure. The method may include the step of actively lowering the person's intrathoracic pressure. Also, the person's effective circulating blood volume is lowered while the person's intrathoracic pressure is lowered to thereby non-invasively reduce venous blood volume in the brain to treat elevated intracranial pressure and/or brain edema.

In one step, the person's effective circulating blood volume is reduced by utilizing a lower body negative pressure (LBNP) apparatus. The person's intrathoracic pressure may be lowered by preventing air from entering the lungs while lifting the chest and/or by actively removing air from the lungs. In another step, the person's effective circulating blood volume and/or intrathoracic pressure are altered using at least one physiological parameter to guide the therapy. Further, the person may be suffering from brain injury secondary to stroke, cerebral bleed, brain surgery, cardiac arrest, brain edema, brain swelling, brain lymphedema, and other forms of traumatic and non-traumatic brain injury.

In another embodiment, the invention provides a device to non-invasively lower ICP and increase cerebral perfusion pressure that non-invasively reduces venous blood volume in the brain that encircles the lower body and can be used to generate LBNP.

In a further embodiment, a system is provided to non-invasively lower ICP and increase cerebral perfusion pressure. The system comprises a device to actively lower the person's intrathoracic pressure, and a device to lower the person's effective circulating blood volume while the person's intrathoracic pressure is lowered to thereby reduce venous blood volume in the brain to treat elevated intracranial pressure.

### BRIEF DESCRIPTION OF THE DRAWINGS

FIG. 1 illustrates one embodiment of a system that may be used to manipulate intrathoracic pressures using a resistor valve (also referred to herein as an ITD) according to the invention.

FIG. 2 illustrates another embodiment of a system that may be used to manipulate intrathoracic pressures using a resistor valve (ITD), particularly when the person is breathing.

FIG. 3 illustrates still another embodiment of a system that may be used to manipulate intrathoracic pressures using an intrathoracic pressure regulator (also referred to herein as an ITPR) according to the invention.

FIG. 4 is a graph illustrating the manipulation of intrathoracic pressures while the person's circulating blood volume is lowered in order to lower intracranial pressures.

FIG. 5 illustrates a machine to lower body native pressure (in order to effectively lower circulating blood volume) that is used in combination with an ITD.

FIG. 6 is a flow chart illustrating one embodiment of a method for non-invasively lowering a person's ICP and increasing cerebral perfusion according to the invention.

### DETAILED DESCRIPTION OF THE INVENTION

The devices and methods in this application provide a systems, devices and methods to non-invasively 1) reduce total circulating blood volume and 2) lower intrathoracic pressure in order to lower intracranial pressure (ICP) and improve brain perfusion by reducing the volume of venous blood in the brain and simultaneously providing sufficient venous volume in the thorax to maintain adequate or enhanced circulation to and through the heart. A variety of techniques and equipment may be used to reduce total circulating blood volume and to lower intrathoracic pressure.

For example, intrathoracic pressures may be reduced in both breathing and non-breathing patients. For patients that are spontaneously breathing, a valve or other mechanism to block the inflow of air into the lungs when inspiring may be used. As one example a pressure responsive valve (or ITD) may be employed. Such a valve prevents or resists the flow of air into the lungs when the patient attempts to inhale. If a certain negative intrathoracic pressure is obtained, the valve opens to provide ventilation to the patient. As another example, an intrathoracic pressure regulator (ITPR) could be used. The regulator may be constructed of a vacuum or other pressure source (including a ventilator) that applies a negative pressure or resistance as the person attempts in inspire.

For those not breathing, the person's chest could be actively lifted or the person induced to gasp while connected to an ITD. As another option, after a positive pressure breath from a mechanical ventilator, respiratory gases may be extracted from the lungs to create a lower the intrathoracic pressure.

Various techniques to lower intrathoracic pressure for both breathing and non-breathing patients are described in U.S. Pat. Nos. 5,551,420; 5,692,498; 6,062,219; 6,526,973; 6,604,523; 7,210,480; 6,986,349; 7,204,251; 5,730,122; 7,195,012; 7,185,649; 7,082,945; 7,195,013, 7,836,881; 7,766,011; 6,938,618; 7,275,542; 8,011,367; and U.S. Patent Publication Nos. 2010/0319691 and 2011/0098612, and in A & A, January 2007 vol. 104 no. 1 157-162, Intrathoracic Pressure Regulation Improves 24-Hour survival in a Porcine Model of Hypovolemic Shock, Demetris Yannopoulos, MD, Scott McKnite, BSc, Anja Metzger, PhD and Keith G. Lurie, MD, and Resuscitation, 2006 September; 70(3):445-53. Epub 2006 Aug. 9, Intrathoracic pressure regulation improves vital organ perfusion pressures in normovolemic and hypovolemic pigs, Yannopoulos D, Metzger A, McKnite S, Nadkarni V, Aufderheide T P, Idris A, Dries D, Benditt D G, Lurie K G. The complete disclosures of all of these references are herein incorporated by reference.

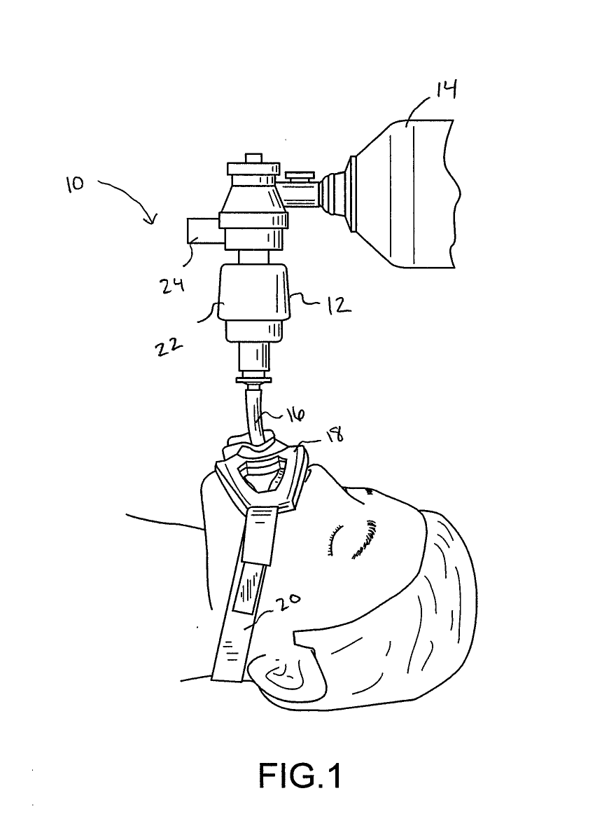

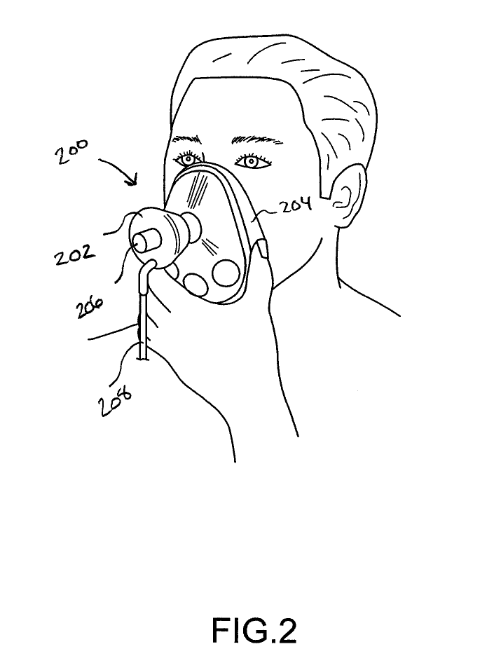

As previously described, one exemplary way to lower intrathoracic pressures in both spontaneously breathing and non-breathing subjects is by use of a resistor valve, a pressure valve, or the like (also referred to herein as an ITD). Examples of systems incorporating ITDs are shown in FIGS. 1 and 2. Referring first to FIG. 1, one embodiment of a system 10 for lowering intrathoracic pressure will be described. System 10 comprises an ITD 12 that is coupled to a ventilatory bag 14 at one end and an endotracheal tube 16 at the other end. An interface 18 that fits around the patient's mouth along with a head strap 20 may be used to secure endotracheal tube 16 in the desired position. Although shown with an endotracheal tube, it will be appreciated that other patient interfaces could be used, such as a facial mask, laryngeal mask, or the like. ITD 12 comprises a housing 22 that contains a pressure responsive valve (hidden from view). The pressure responsive valve is configured to be in a closed position when the patient's chest is actively lifted (such as when performing ACD CPR) or when the patient is inspiring. In this way, air is prevented from entering the lungs to increase the amount of negative intrathoracic pressure. In the event that the negative intrathoracic pressure becomes too great, the pressure-responsive valve is configured to open to allow air to flow to the lungs. Upon exhalation, respiratory gases from the lungs are allowed to freely pass through housing 22 and out exit port 24. When needed, ventilation may be provided by squeezing bag 14 which allows respiratory gases to flow through housing 22 and into the lungs. It will be appreciated that other ventilation sources could also be used.

Hence, with system 10 a person's intrathoracic pressure may be lowered each time a patient attempts to inhale, when the person's chest is actively lifted, when the patient is caused to gasp, and the like. System 10 may be used in combination with any mechanism or technique that effectively lowers the patient's blood circulation to thereby reduce ICP.

FIG. 2 illustrates a system 200 that may be used to lower a person's intrathoracic pressure while breathing. System 200 includes an ITD 202 that is coupled to a facial mask 204. ITD 202 may be constructed in a similar manner to ITD 12 of FIG. 1. In this manner, when mask 204 is coupled to a person's face and the person breathes, air will be prevented from reaching the lungs during each attempted inspiration. This causes the person's intrathoracic pressure to lower during each attempted inhalation. In the event that the negative intrathoracic pressure becomes too great, the pressure-responsive valve is configured to open to allow air to flow to the lungs. Upon exhalation, respiratory gases from the lungs are allowed to freely pass through ITD 202 and out an exit port 206. A ventilator gas can also be provided through a line 208.

Exemplary resistor valves, including those similar to ITDs 12 and 202, are described in U.S. Pat. Nos. 5,551,420; 5,692,498; 6,062,219; 6,526,973; 6,604,523; 7,210,480; 6,986,349; 7,204,251; 5,730,122; 7,195,012; 7,185,649; 7,082,945; 7,195,013, 7,836,881; 7,766,011; 6,938,618; 7,275,542; 8,011,367, previously incorporated by reference.

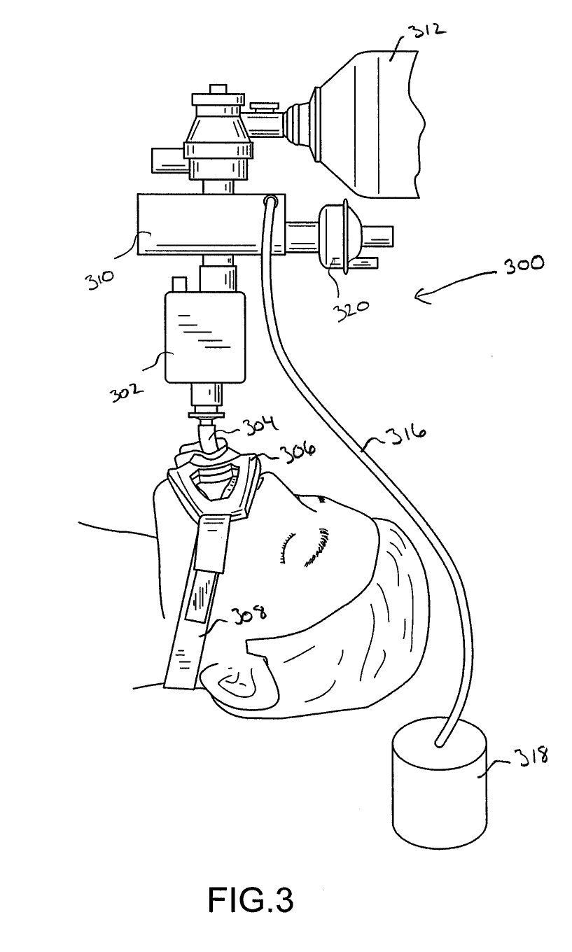

For the non-breathing patient a lower level negative intrathoracic pressure may be generated after each positive pressure breath with an intrathoracic pressure regulator (ITPR). An example of an intrathoracic pressure regulation system 300 is shown in FIG. 3. System 300 may be constructed of a valve system 302 that is coupled to an endotracheal tube 304 that interfaces with the patient's lungs. An interface 306 that fits around the patient's mouth along with a head strap 308 may be used to secure endotracheal tube 304 in the desired position. Although shown with an endotracheal tube, it will be appreciated that other patient interfaces could be used, such as a facial mask, laryngeal mask, or the like.

System 300 further includes a manifold 310 that is fluidly coupled to valve system 302 and to a ventilator bag 312 (or other source of respiratory gases). Also coupled to manifold 310 is a vacuum line 316 that is in fluid communication with a vacuum source 318. A safety valve 320 is also coupled to manifold 310.

In operation, a continuous vacuum is created using vacuum source 318, creating a negative pressure within manifold 310. In turn, this causes respiratory gases to be evacuated from the person's lungs via endotracheal tube 304 and valve system 303. In this way, the person's intrathoracic pressure may be lowered. In the event the intrathoracic pressure is lowered below a threshold level, safety valve 320 opens to lower the pressure in manifold 310 and reduce the vacuum applied to the lungs. The patient may be periodically ventilated by squeezing bag 312 which cases a positive pressure breath to pass through manifold 310, through valve system 302 and into the lungs.

Hence, system 300 provides a way to lower the intrathoracic pressure of a non-breathing person while also providing periodic ventilation. System 300 may be used in combination with any mechanism or technique that effectively lowers the patient's blood circulation to thereby reduce ICP.

In some cases, system 300 could also be used with a breathing person, where the vacuum or negative pressure is applied at least periodically to the person's lungs (such as with a ventilator) so that as the person attempts to inhale, the resistance is increased thereby lowering intrathoracic pressure.

Examples of ITPR's, such as the one used in system 300, are also described in U.S. Published Application Nos. 2010/0319691 and 2011/0098612, and in A & A, January 2007 vol. 104 no. 1 157-162, Intrathoracic Pressure Regulation Improves 24-Hour survival in a Porcine Model of Hypovolemic Shock, Demetris Yannopoulos, MD, Scott McKnite, BSc, Anja Metzger, PhD and Keith G. Lurie, MD, and Resuscitation, 2006 September; 70(3):445-53. Epub 2006 Aug. 9, Intrathoracic pressure regulation improves vital organ perfusion pressures in normovolemic and hypovolemic pigs, Yannopoulos D, Metzger A, McKnite S, Nadkarni V, Aufderheide T P, Idris A, Dries D, Benditt D G, Lurie K G, previously incorporated herein by reference.

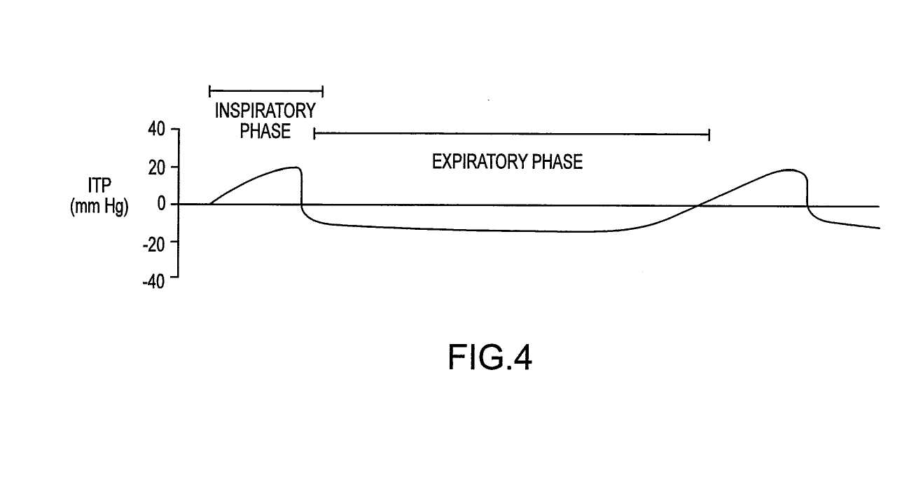

One example how a person's intrathoracic pressure is lowered using an ITD or ITPR is illustrated in FIG. 4. In FIG. 4, when the person exhales, the intrathoracic pressure is generally positive. However, as the person inhales (or the chest is actively lifted), respiratory gases are prevented or hindered from entering the lungs, thereby reducing the intrathoracic pressure. A similar result may be achieved using an ITPR where gases are actively extracted from the lungs. In combination with the lowering of intrathoracic pressure, the person's effective blood circulation may be lowered, such as by drawing blood into the lower extremities. In this way, the person's ICP may be lowered as described herein.

One aspect of the invention uses such methods and devices, including those described above as ITD or ITPR therapy, together with ways to decrease circulating blood volume. In other words, a person's effective circulating blood volume is lowered in combination with lowering the person's intrathoracic pressure in order to lower a person's ICP and increase cerebral perfusion pressure. One way to reduce circulating blood volume is with a lower body negative pressure (LBNP) chamber or similar device. Such devices are used to study the effects of g-forces by the military and NASA and the effects of simulated blood loss by research scientists.

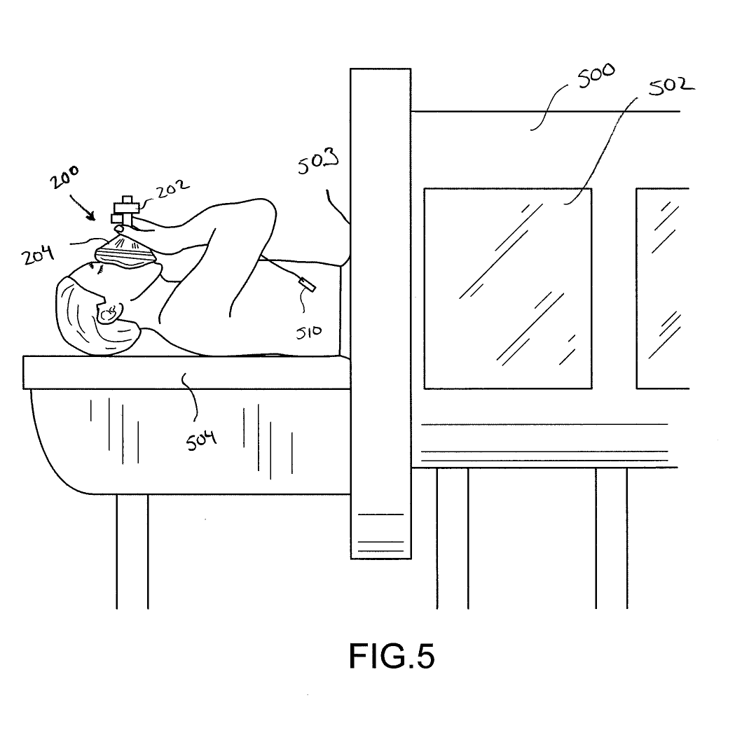

One embodiment of an LBNP 500 is shown in FIG. 5. LBNP is constructed of a chamber 502 having an entrance 503 through which the person's lower body is placed. A support surface 504 is employed to support the user's body while being positioned as shown in FIG. 5. Entrance 503 may include a seal that tightly fits around the person's waist or lower torso to provide an airtight seal between the person's body and the outside environment. In this way, a vacuum may be applied to the chamber 502. In so doing, the pressure surrounding the person's lower body is reduced to draw blood from the thorax and into the lower extremities, thereby effectively reducing the person's circulating blood volume. In other words, more of the person's blood is stored in the lower extremities.

LBNP may be used alone in order to reduce ICP and increase coronary perfusion pressure. Alternatively, LBNP 500 may be used in combination with an ITD or ITPR therapy, including the devices and systems illustrated in FIGS. 1-3. For example, as shown in FIG. 5 the patient is utilizing system 200, including ITD 202 and facial mask 204. With facial mask 204 sealed to the person's face, the person breathes through ITD 202 to lower the intrathoracic pressure as previously described. At the same time, the person's effective circulating blood volume is reduced, thereby using two mechanisms to reduce ICP and increase coronary perfusion pressure.

Optionally, one or more sensors (such as sensor 510) may be used to monitor various physiological parameters. For example, sensor may be used to monitor blood pressure, ICP, other measures of blood flow, and the like. Data from these sensors may be used to regulate the level of the vacuum in LBNP 500. This may be done in an automated manner using a computer system. This data may also be used to notify the medical caregiver about the levels of intrathoracic pressure, whether the ITD or ITPR therapy should be adjusted and/or to modify the settings on the equipment used to manipulate intrathoracic pressures.

Use of a lower body negative pressure chamber by itself as a therapy or in combination with ITD or ITPR for the treatment of the clinical problem of increased intracranial pressure and brain edema is critical. The LBNP alone or in combination with an ITD or ITPR device provides way to treat patients suffering from a variety of ailments and conditions, such as brain edema, stroke, cerebral bleed, brain surgery, cardiac arrest, and other forms of traumatic and non-traumatic brain injury.

In one embodiment, the LBNP device is regulated to provide continuous, graded, pulsatile or intermittent LBNP and may be regulated either independently or in concert with the ITPR or ITD device. This could be accomplished by using a computer controller that controls operation of the LBNP device as well as any device used to lower intrathoracic pressure. The regulation may be linked to one or more physiological measurements that are made on the patient. These measurements may be taken by sensors or other detectors and transmitted to the computer controller having one or more processors and associated memory and software in order to modify the treatment, including the parameters for the LBNP device and the ITD or ITPR device. The LBNP chamber may be connected to an independent power source to regulate the vacuum or a self-contained unit. The LBNP unit may be designed to fit one size or many different sized patients.

One LBNP embodiment may comprise a self-contained unit that surrounds the subject's legs and fits around the subject with a tight seal or gasket at the level of the waist or lower abdomen. A regulation system, such as the computer controller, may be employed to generate continuous or intermittent negative pressure within this chamber from between about −5 to about −100 mmHg to draw blood into the lower body and thus reduce the effective circulating blood volume. Additional ways to alter LBNP may be provided intermittently to prevent stagnation of blood in the lower body, including in one embodiment the use of intermittent compression of the lower extremities when still subjected to LBNP. In one embodiment LBNP may be used, and regulated simultaneously, with an ITD or ITPR device to lower ICP and increase circulation to the brain and heart. In such an embodiment, the LBNP reduces circulating blood volume to the brain and the ITPR and ITD draws more blood back to the thorax and out of the brain. The combined physiological mechanisms increase cardiac filling, cardiac output, and systemic blood pressure while simultaneously lowering brain pressures, especially ICP and cerebral venous pressures. The net effect is to increase cerebral perfusion and lower ICP. Such an embodiment also reduces brain edema by actively drawing fluid out of the brain cells due to the reduction in cerebral venous pressure. Physiological monitoring of blood pressure and/or ICP or other measures of blood flow can be used to regulate the level of the vacuum in the LBNP and the changes of intrathoracic pressure generated by the ITD or ITPR. This may be done using a computer system or controller as previously described. For example, if the systemic blood pressure is too low, a closed loop computer algorithm can be used that takes the blood pressure information and regulates the level of LBNP and/or negative intrathoracic pressure generated by the ITPR and thereby increase systemic pressures.

Also, in some cases a LBNP system may be used to apply a vacuum to one and/or two legs at a time, or simultaneously to the entire lower body. Also, an ongoing shrink wrap may be used with the same body parts. In a further alternative, invasive techniques may be used to lower blood volume, including by physically removing blood from the body. This blood may be temporarily saved and preserved (such as by continuous oxygenation) so that it may be reintroduced back into the patient following a procedure where changes in intrathoracic pressures are manipulated (such as by using the ITD or ITPR as previously described).

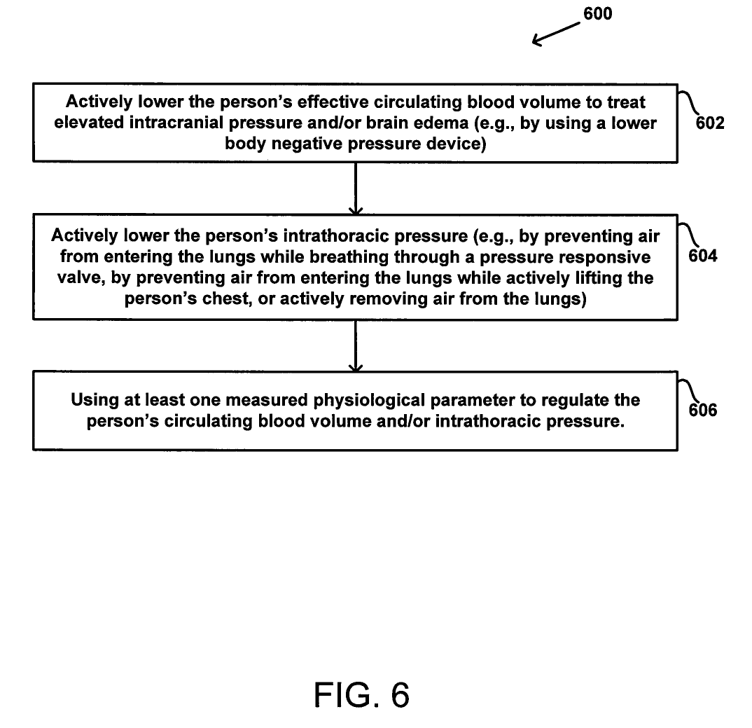

Referring now to FIG. 6, one exemplary method 600 for lowering a person's ICP and increasing cerebral perfusion will be described. As illustrated in step 602, The person's effective circulating blood volume is reduced in order to treat elevated intracranial pressure and/or brain edema. This may be accomplished, for example, by using a lower body negative pressure device. In some cases, this step may be performed alone, without any of the subsequent steps.

In some cases, and as illustrated in step 604, the person's intrathoracic pressure may be actively lowered. This may be performed in combination with step 602 such that while the person's circulating blood volume is in a reduced state, the person's intrathoracic pressure may also be lowered. This may be accomplished, for example, by preventing air from entering the lungs while breathing through a pressure responsive valve, by preventing air from entering the lungs while actively lifting the person's chest, or actively removing air from the lungs.

Optionally, as illustrated in step 606, one or more physiological parameters may be measured and used to regulate the person's circulating blood volume and/or intrathoracic pressure. This may be accomplished, for example, by using various sensors that feed data to a computer system that may in turn be used to control any equipment used to reduce the person's lower body pressure and/or to reduce the person's intrathoracic pressure.

The invention has now been described in detail for purposes of clarity and understanding. However, it will be appreciated that certain changes and modifications may be practiced within the scope of the appended claims.

What is claimed is:

1. A method for non-invasively lowering a person's ICP and increasing cerebral perfusion pressure, comprising:
actively lowering the person's intrathoracic pressure;
lowering the person's effective circulating blood volume while the person's intrathoracic pressure is lowered to reduce venous blood volume in the brain to treat at least one of elevated intracranial pressure or brain edema.

2. A method as in claim 1, wherein the person's effective circulating blood volume is reduced by utilizing a lower body negative pressure (LBNP) apparatus that is positioned about the person's lower body.

3. A method as in claim 2, wherein the person's intrathoracic pressure is lowered by preventing air from entering the lungs while breathing through a pressure responsive valve.

4. A method as in claim 2, wherein the person's intrathoracic pressure is lowered by preventing air from entering the lungs while actively lifting the person's chest.

5. A method as in claim 2, wherein the person's intrathoracic pressure is lowered by actively removing air from the lungs.

6. A method as in claim 1, further comprising using at least one measured physiological parameter to assist in regulating the person's circulating blood volume and/or intrathoracic pressure.

7. A method as in claim 1, wherein the person is suffering from a condition selected from the group consisting of: brain injury secondary to stroke, cerebral bleed, brain surgery, cardiac arrest, brain edema, lymphedema, and other forms of traumatic and non-traumatic brain injury.

8. A device to non-invasively lower ICP and increase cerebral perfusion pressure, the device comprising:
an apparatus that is configured to encircle a person's lower body, wherein the apparatus is configured to generate a lower body negative pressure that non-invasively reduces venous blood volume in the brain.

9. A system to lower ICP and increase cerebral perfusion pressure, comprising:
a device to actively lower the person's intrathoracic pressure; and
an apparatus that is configured to lower the person's effective circulating blood volume while the person's intrathoracic pressure is lowered to thereby non-invasively reduce venous blood volume in the brain to treat at least one of elevated intracranial pressure or brain edema.

10. A system as in claim 9, wherein the apparatus comprises a lower body negative pressure arrangement that is configured to be positioned about the person's lower body.

11. A system as in claim 9, wherein the device comprises a housing and a pressure responsive valve disposed in the housing that is configured to prevent air from entering the lungs while breathing through the pressure responsive valve until a certain negative intrathoracic pressure is achieved, whereupon the pressure responsive valve opens to permit air to enter the lungs.

12. A system as in claim 9, wherein the device comprises a housing and a pressure responsive valve disposed in the housing that is configured to prevent air from entering the lungs while actively lifting the person's chest valve until a certain negative intrathoracic pressure is achieved, whereupon the pressure responsive valve opens to permit air to enter the lungs.

13. A system as in claim 9, wherein the device comprises a vacuum source that is configured to actively remove air from the lungs.

14. A method for lowering a person's ICP and increasing cerebral perfusion pressure, comprising:
actively lowering the person's effective circulating blood volume to treat at least one of elevated intracranial pressure or brain edema.

15. A method as in claim 14, wherein the person's effective circulating blood volume is lowered using a lower body negative pressure device.

16. A method as in claim 14, further comprising actively lowering the person's intrathoracic pressure while the person's effective circulating blood volume is lowered.

17. A method as in claim 16, wherein the person's intrathoracic pressure is lowered by preventing air from entering the lungs while breathing through a pressure responsive valve.

18. A method as in claim 16, wherein the person's intrathoracic pressure is lowered by preventing air from entering the lungs while actively lifting the person's chest.

19. A method as in claim 16, wherein the person's intrathoracic pressure is lowered by actively removing air from the lungs.
